(19) United States
(12) Patent Application Publication
(10) Pub. No.: US 2020/0230973 A1
(43) Pub. Date: Jul. 23, 2020

(54) COLOR PRINTER WITH PRINTING PRECISION CALIBRATING FUNCTION

(71) Applicant: AVISION INC., Hsinchu (TW)

(72) Inventors: Shao-Lan SHENG, Hsinchu City (TW); Yen-Cheng CHEN, Baoshan Township (TW)

(21) Appl. No.: 16/838,382

(22) Filed: Apr. 2, 2020

Related U.S. Application Data
(62) Division of application No. 15/867,422, filed on Jan. 10, 2018.

(30) Foreign Application Priority Data
Jan. 25, 2017 (TW) 106102816

(51) Int. Cl. B41J 2/21; H04N 1/00; H04N 1/193

(52) U.S. Cl. CPC B41J 2/2132; B41J 2/2146; B41J 2/2135; B41J 2/2103; H04N 1/00087; H04N 1/1931; H04N 1/00037

(57) ABSTRACT

A color printer includes image forming assemblies, a contact image sensor (CIS) and a processor. The image forming assemblies generate image forming substances, which have different colors and are transfer-printed onto a belt assembly. The CIS detects the image forming substances on the belt assembly passing by the CIS to obtain a detected result. The processor electrically connected to the CIS receives the detected result and determines whether an arrangement of the image forming substances with a same color satisfies a predetermined angle of the CIS according to the detected result.

### CROSS-REFERENCE TO RELATED APPLICATIONS

This application is a divisional application of the co-pending U.S. application Ser. No. 15/867,422, filed on Jan. 10, 2018, which claims priority of No. 106102816 filed in Taiwan R.O.C. on Jan. 25, 2017 under 35 USC 119, the entire content of which is hereby incorporated by reference.

### BACKGROUND OF THE INVENTION

### Field of the Invention

This disclosure relates to the technical field of printing calibrating, and more particularly to a printing precision calibrating structure and a printing precision calibrating method.

### Description of the Related Art

In the conventional printing precision calibrating structure, as can be seen from the structure of a color printer 10 in FIG. 1, four image forming assemblies 110, 120, 130 and 140 of C, M, Y and K are separately assembled within the structure of the color printer 10, wherein each developer assembly (including a drum, for example) 112 performs transfer printing so that each of the color printing pixels P1, P2, Pn is formed when the corresponding four color pixels CP1, MP1, YP1, KP1, CP2, MP2, YP2, KP2 . . . CPn, MPn, YPn, KPn and the like are screen printed on a belt assembly 150. A pick-up roller 170 guides the sheet medium on a supply tray 160 to enter an input passage 162. When the sheet medium passes through a transmission roller 152, the color pixels are transfer-printed onto the sheet medium through the belt assembly 150, and finally the sheet medium is outputted to a discharge tray 192 from a discharge roller 190. The effects of color print imaging rely on the accuracy of the positions of these color pixels. However, on the mass production line, the relative positions of the four image forming assemblies 110, 120, 130 and 140 of C, M, Y and K on different machines can not be exactly the same. Thus, before the color printer 10 is shipped out and after the image forming assemblies are replaced, the positions of these color pixels, such as CP1, MP1, YP1, KP1 . . . and the like, need to be obtained to perform the print control calibration, so that the positions of C, M, Y and K color pixels become more accurate to achieve the optimum imaging effect.

The above-mentioned color pixels are transfer-printed onto the belt assembly 150 through the image forming assemblies 110, 120, 130 and 140, and then the color pixels are transfer-printed onto the sheet medium through the transmission roller 152. However, after being transfer-printed through the transmission roller 152, some of the color pixels may remain on the belt assembly 150. At this time, the residual color pixels on the belt assembly 150 are cleaned by a scraper assembly 154.

In the prior art, multiple sensors (not shown) are used to sense the relative positions of the four image forming assemblies 110, 120, 130 and 140. So, the assembly is complicated, needs the computation basis of different sensors and mechanisms, and also increases the calibration and computation difficulties.

### BRIEF SUMMARY OF THE INVENTION

In order to solve the above-mentioned problems of the existing technology, an objective of this disclosure is to provide a printing precision calibrating structure, wherein the structure mainly needs a linear image sensor, so that both the assembly and the calibration computations are relatively simple. In the calculation and computation processes, the objective of this disclosure can be achieved according to at least two reference points, and complicated patterns or software calculations are not needed.

An objective of this disclosure is to provide a simple calibration structure. So, the technical content of this disclosure provides a printing precision calibrating structure including image forming assemblies, a transmission path and a linear image sensor. The image forming assemblies generate image forming substances, and the image forming assemblies are arranged in order. The image forming substances pass through the transmission path. The linear image sensor is disposed downstream of the image forming assemblies; wherein the image forming assemblies individually generate the image forming substances transmitted within the transmission path; wherein the linear image sensor detects the image forming substances, which hare individual provided by the image forming assemblies and used as the operation processing parameters for printing precision calibrating.

Another objective of this disclosure is to provide a simple computation system to achieve the effects of color registration and color alignment. So, this disclosure provides a printing precision calibrating method applied to a color printer, and the printing precision calibrating method includes steps of: generating image forming substances with different colors using image forming assemblies; using a linear image sensor to detect the image forming substances passing by the linear image sensor; determining whether an arrangement of the image forming substances with the same color satisfies a predetermined angle of the linear image sensor. When the arrangement of the image forming substances with the same color does not satisfy the predetermined angle of the linear image sensor, the processor performs the parameter computation to calibrate the printing parameters.

The useful effects of this disclosure will be described in the following. In this disclosure, the single linear image sensor is disposed downstream of the image forming assemblies, and the linear image sensor is disposed at a fixed predetermined angle to measure the image forming substances individually generated by the image forming assemblies, to achieve the effects of providing the simple structure assembly and convenient computation parameters, and to have the functions of color registration and color alignment at the same time.

### BRIEF DESCRIPTION OF THE SEVERAL VIEWS OF THE DRAWINGS

FIG. 1 is a schematically structural cross-sectional view showing a conventional color printer.

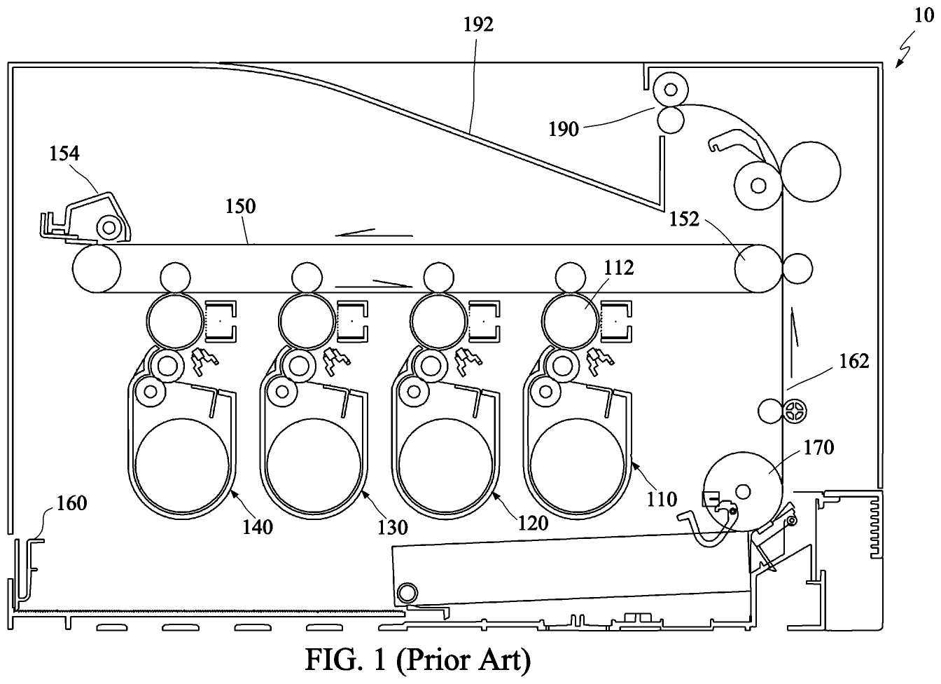

FIG. 2A is a schematically structural cross-sectional view showing a color printer according to an embodiment of this disclosure.

FIG. 2B is a schematically structural cross-sectional view showing a color printer according to another embodiment of this disclosure.

FIG. 2C is a schematically structural cross-sectional view showing a color printer according to still another embodiment of this disclosure.

FIG. 3 is a detailed top view showing positions of relevant image forming substances according to an embodiment of this disclosure.

FIG. 4 is a detailed top view showing positions of relevant image forming substances according to another embodiment of this disclosure.

FIG. 5 is a block diagram showing a control system of this disclosure.

FIG. 6 is a flow chart showing an example of the control system of this disclosure.

### DETAILED DESCRIPTION OF THE INVENTION

Hereinafter, embodiments of this disclosure will be described in detail with reference to the accompanying drawings. However, this disclosure may be embodied in many different forms and should not be construed as limited to the specific embodiments set forth herein. On the contrary, the embodiments are provided to explain the principles of this disclosure and its practical application to thereby enable those skilled in the art to understand various embodiments of this disclosure and various modifications as are suited to the particular use contemplated.

In the drawings, the thickness of layers and regions is exaggerated for clarity of the device. The same reference numbers indicate the same components throughout the specification and the drawings.

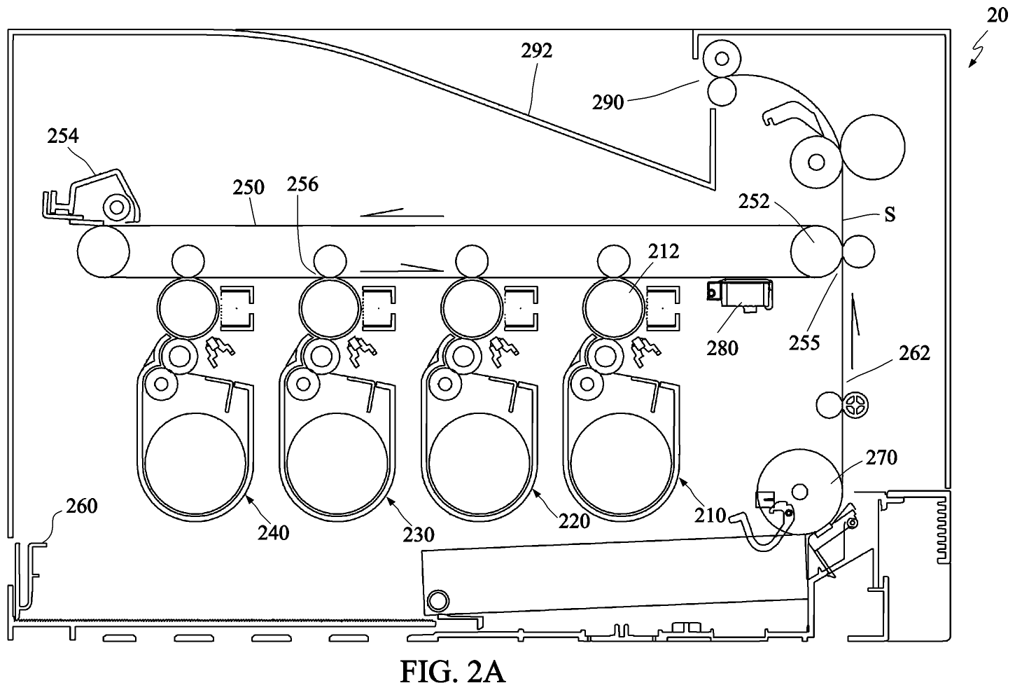

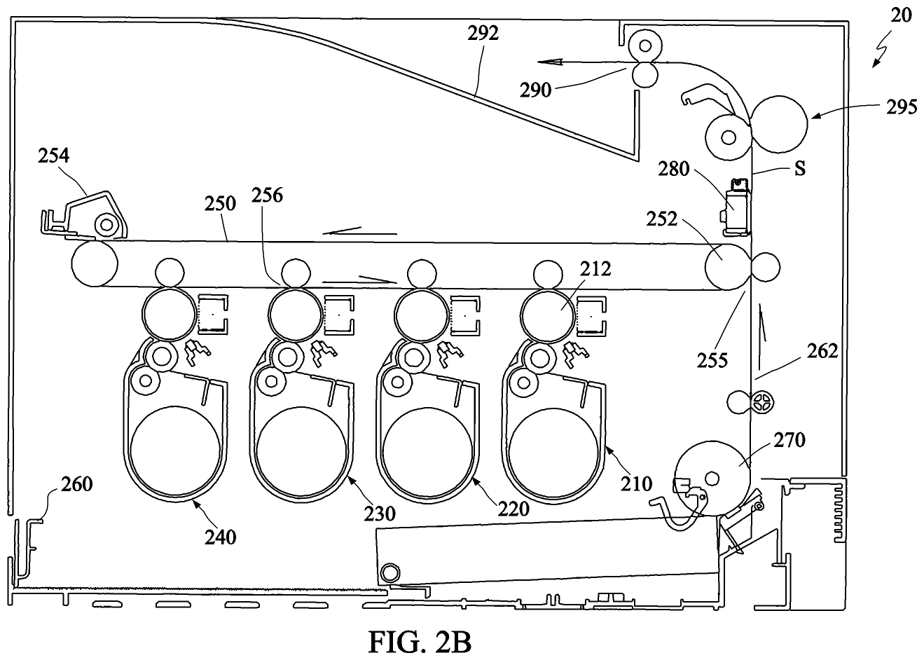

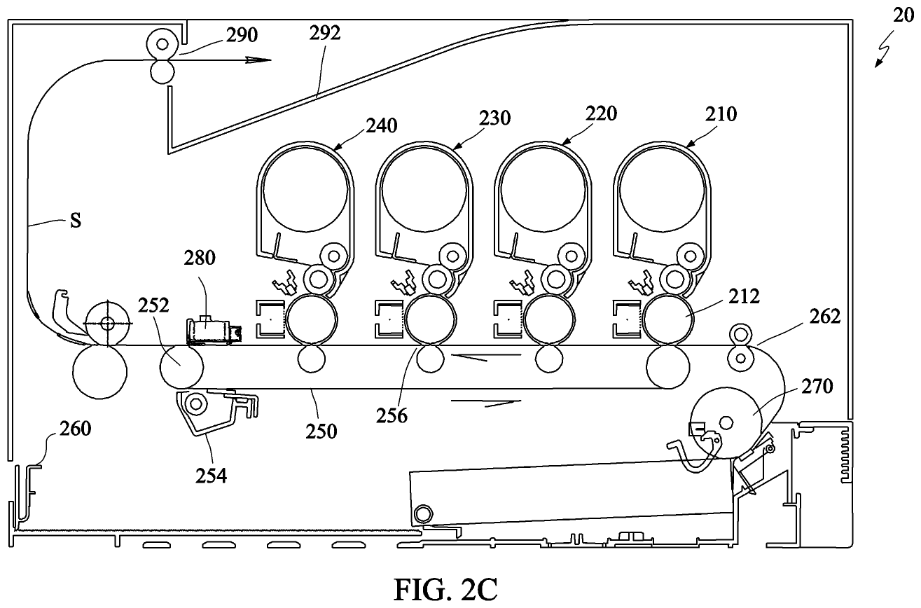

FIG. 2A is a schematically structural cross-sectional view showing a color printer 20 according to an embodiment of this disclosure. Referring to FIG. 2A, this disclosure provides a printing precision calibrating structure, mechanism, system or module, which includes image forming assemblies (also referred to as color developer assemblies) 210, 220, 230 and 240, a transmission path 256 and a linear image sensor 280. The image forming assemblies 210, 220, 230 and 240 are arranged in order and generate image forming substances. In this embodiment, the image forming substance is, for example, a CYMK image forming agent (such as toner) carried on a belt assembly 250, the image forming substances pass through the transmission path 256, and the image forming substances and the belt assembly 250 pass through the transmission path 256 in a forwarding direction perpendicular to the image forming assemblies. The linear image sensor 280 is disposed downstream of the belt assembly 250, downstream of the image forming assemblies 210, 220, 230 and 240, and upstream of a transfer printing portion 255. The image forming substances on the belt assembly 250 can be transfer-printed onto the sheet medium at the transfer printing portion 255, and finally the sheet medium is outputted from a discharge roller 290 to a discharge tray 292. The image forming assemblies 210, 220, 230 and 240 individually generate the image forming substances on the surfaces of the image forming assemblies. The linear image sensor 280 is used to detect the time instants when the image forming assemblies 210, 220, 230 and 240 individually generate the image forming substances relative to the detected position, and the detected results are used as the parameters for operation processing and printing precision calibrating. These image forming assemblies include the image forming substances (such as toners) with mutually different colors.

The image forming assemblies 210, 220, 230 and 240 include printing elements with different colors. In this embodiment, the image forming assembly 210 includes black toner (K), the image forming assembly 220 includes red toner (M), the image forming assembly 230 includes yellow toner (Y) and the image forming assembly 240 includes cyan toner (C), wherein the C, M, Y and K toners are arranged in order. In the process of calibrating the printing precision, the image forming substances travel from a developer assembly 212 into the transmission path 256. In this embodiment, the printing precision calibrating structure further includes a belt assembly 250 for carrying the image forming substances, and transmitting the image forming substances in the forwarding direction perpendicular to the axial directions of the image forming assemblies 210, 220, 230 and 240. The linear image sensor 280 is used to detect the image forming substances provided on the same side of the belt assembly 250. The image forming assemblies 210, 220, 230 and 240 individually provide the image forming substances onto the belt assembly 250, and the belt assembly 250 directly carries the image forming substances. The sheet medium S is carried by a supply tray 260, a pick-up roller 270 guides the sheet medium S to enter an input passage 262, and when the sheet medium S passes a transmission roller 252 at the transfer printing portion 255, the image forming substances are transfer-printed onto the sheet medium S.

If the above-mentioned image forming substances are transfer-printed onto the belt assembly 250 through the image forming assemblies 210, 220, 230 and 240, the image forming substances are transfer-printed onto the sheet medium through the transmission roller (or referred to as transfer roller) 252. However, after being transfer-printed through the transmission roller 252, the image forming substances on the belt assembly 250 may still remain on the belt assembly 250. At this time, the residual image forming substances on the belt assembly 250 are cleaned by a scraper assembly 254. Thus, the above-mentioned image forming substance can be generated when test printing is performed after maintenance or when the calibration is required, and the obtained precision calibrating parameters are used for the next normal printing.

FIG. 2B is a schematically structural cross-sectional view showing the color printer 20 according to another embodiment of this disclosure. Referring to FIG. 2B, this disclosure provides a printing precision calibrating structure, which includes image forming assemblies 210, 220, 230 and 240, a transmission path 256 and a linear image sensor 280. The image forming assemblies 210, 220, 230 and 240 are arranged in order and generate image forming substances. The image forming substances pass through the transmission path 256, and the image forming substances pass through the transmission path 256 in the forwarding direction perpendicular to the axial directions of the image forming assemblies. The linear image sensor 280 is disposed downstream of the belt assembly 250 and the transfer printing portion 255 and upstream of the discharge roller 290 and a fixing unit 295. The image forming assemblies 210, 220, 230 and 240 individually generate the image forming substances on the surfaces of the image forming assemblies. The linear image sensor 280 is used to detect the time instants when the image forming assemblies 210, 220, 230 and 240 individually generate the image forming substances relative to the detected position, and the detected results are used as the operation processing parameters.

The printing precision calibrating structure further includes an input passage 262 and a transfer roller 252, and the transfer roller 252 is used to transfer the image forming substances from the belt assembly 250 onto the sheet medium S of the input passage 262. The transmission roller 252 is disposed between the linear image sensor 280 and the image forming assemblies 210, 220, 230 and 240.

FIG. 2C is a schematically structural cross-sectional view showing the color printer 20 according to still another embodiment of this disclosure. Referring to FIG. 2C, this disclosure provides a printing precision calibrating structure, which includes image forming assemblies 210, 220, 230 and 240, a transmission path 256 and a linear image sensor 280. The image forming assemblies 210, 220, 230 and 240 are arranged in order and generate image forming substances. The image forming substances pass through the transmission path 256, and the image forming substances and the sheet medium S pass through the transmission path 256 in the forwarding direction perpendicular to the axial directions of the image forming assemblies. The linear image sensor 280 is disposed downstream of the belt assembly 250 and the image forming assemblies 210, 220, 230 and 240. The image forming assemblies 210, 220, 230 and 240 individually generate image forming substances on the surfaces of the image forming assemblies. The linear image sensor 280 is used to detect the time instants when the image forming assemblies 210, 220, 230 and 240 individually generate the image forming substances relative to the detected position, and the detected results are used as the operation processing parameters.

The printing precision calibrating structure further includes an input passage 262 and a supply tray 260. After the sheet medium enters the input passage 262 from the supply tray 260, the sheet medium S is continuously transported into the transmission path 256 to carry or receive the image forming substances generated by the image forming assemblies 210, 220, 230 and 240. The linear image sensor 280 is used to detect the image forming substances provided on the sheet medium S.

The linear image sensor 280 includes multiple sensor cells (or referred to as image sensing elements), and the sensor cells are arranged in a straight line with predetermined gaps formed between the sensor cells. In this embodiment, the gaps are known. The sensor cells of the linear image sensor 280 generate different voltages for the intensities of reflected light or for different colors. There are two types of products, including a charge-coupled device (CCD) type image sensor and a contact image sensor (CIS), in the market. More particularly, the CIS is widely used in scanners, and has the low price.

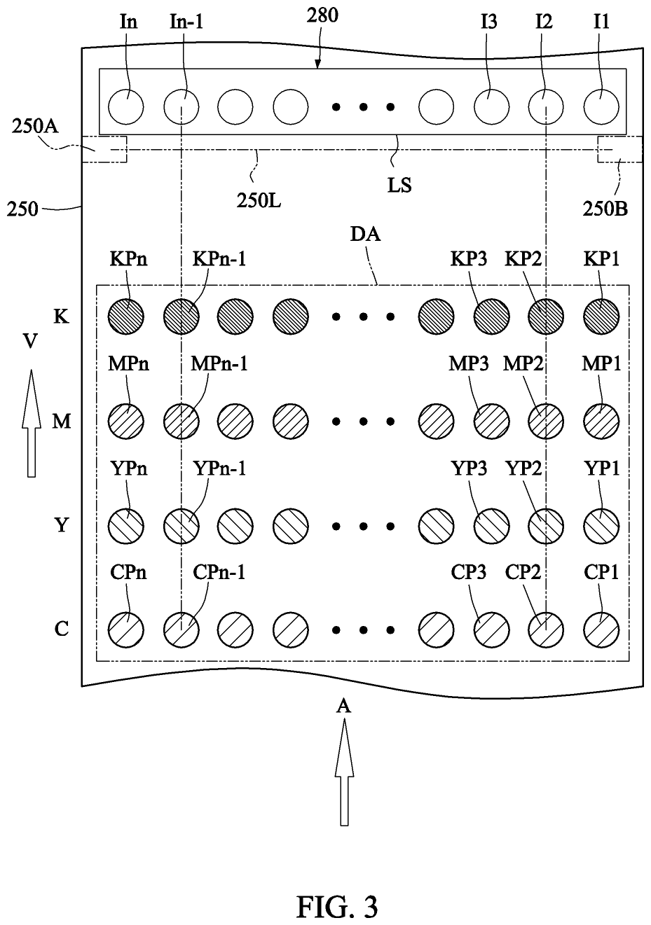

FIG. 3 is a detailed top view showing positions of relevant image forming substances according to an embodiment of this disclosure. Referring to FIG. 3, the image forming substances entirely and longitudinally distributed in a distribution area DA are individually attached to the belt assembly 250 from the image forming assemblies 210, 220, 230 and 240 at a certain speed V, and the connection lines between two image forming substances (e.g., KP1 and KPn, MP1 and MPn, YP1 and YPn or CP1 and CPn) with the same color are ideally perpendicular to the forwarding direction A of the image forming substance (i.e., perpendicular to the running direction A of the belt assembly 250). The linear image sensor 280 is disposed downstream of the image forming assemblies 210, 220, 230 and 240, and a main scan direction (a direction in which the sensor cells I1 to In are arranged) of the linear image sensor 280 is perpendicular to the forwarding direction A. In the process of calibrating the printing precision, each of the image forming assemblies 210, 220, 230 and 240 generates the image forming substances attached to the belt assembly 250. When the image forming substances pass by the linear image sensor 280, the sensor cells I1 to In sense the image forming substances, and send a message to the processor to enable the processor to record the position and time of the sensed image forming substance. After the processor computes the time represented by each of the colors of the image forming substances, the processor determines whether the linear image sensor 280 concurrently captures the image forming substances with the same color (color printing pixels KP1 to KPn, MP1 to MPn, YP1 to YPn and/or CP1 to CPn), and determines whether positions of the different image forming substances (e.g., KP2, MP2, YP2, CP2) captured by the linear image sensor 280 are the same and repeated (e.g., whether they are captured by the sensor cell I2). If not, then the difference represents the horizontal deviation in FIG. 3, and can be used to control the calibration of the system. It is worth noting that the resolution of the sensor cells may be higher than the resolution of the image forming substances.

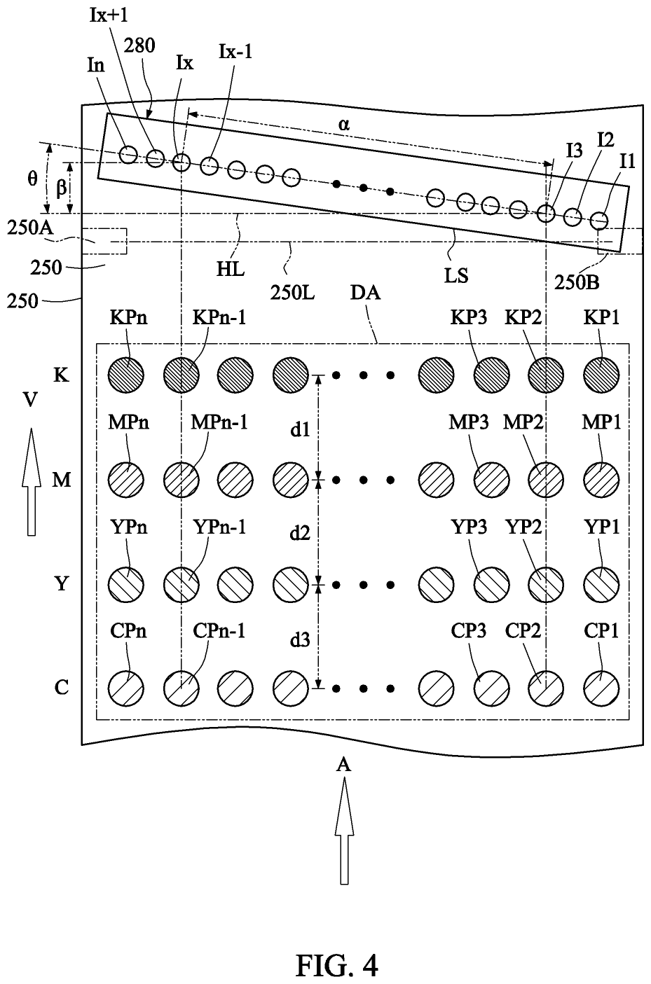

FIG. 4 is a detailed top view showing positions of relevant image forming substances according to an embodiment of this disclosure. Referring to FIG. 4, the image forming substances are individually attached to the belt assembly 250 from the image forming assemblies 210, 220, 230 and 240 at a certain speed V, and the connection lines between two image forming substances (e.g., KP1 and KPn, MP1 and MPn, YP1 and YPn or CP1 and CPn) with the same color are ideally perpendicular to the forwarding direction A of the image forming substance (i.e., perpendicular to the running direction A of the belt assembly 250). The linear image sensor 280 is disposed downstream of the four image forming assemblies, and an angle θ is formed between a main scan direction (or a long side LS) of the linear image sensor 280 and a horizontal line HL (ideally parallel to the connection lines between KP1 and KPn or the axial direction of the image forming assembly) perpendicular to the direction A, as shown in FIG. 4. That is, the main scan direction of the linear image sensor 280 present when the linear image sensor 280 is detecting the image forming substances entirely and longitudinally distributed in a distribution area DA is not perpendicular to the forwarding direction (the same as the running direction A) of the image forming substances when the image forming substances, which are entirely and longitudinally distributed in the distribution area DA and sequentially passing by the long side LS of the linear image sensor 280, are passing through the transmission path 256. An angle between the long side LS of the linear image sensor 280 and the distribution area DA is substantially equal to the angle θ. At this time, the first image forming assembly 210 only prints a horizontal line (e.g., the connection lines between KP1 and KPn) on the image forming substances, or only prints two points (e.g. KP2 and KPn−1). Similarly, each of other three image forming assemblies 220, 230 and 240 also only prints a horizontal line (e.g., the connection line between MP1 and MPn; the connection line between YP1 and YPn; and the connection line between CP1 and CPn) or two points (e.g., MP2 and MPn−1; YP2 and YPn−1; and CP2 and CPn−1). It is worth noting that four image forming assemblies can generate image forming substances with four colors at the same time, so that the control becomes more convenient, but this disclosure is not limited thereto. In other examples, the four image forming assemblies can generate image forming substances with four colors at different time instants to shorten the extending ranges of the image forming substances with four colors in the direction A. This can shorten the sensing range of the linear image sensor 280, complete the sensing more quickly, and also make the smaller sheet medium be used in the test printing of the color printer to reduce the waste. Alternatively, a sheet medium can be used to perform multiple printing precision calibrations. For example, after the linear image sensor 280 senses a to-be-adjusted error at the first time, a second calibration is immediately made to obtain a more accurate calibration result, and so on. Thus, one sheet medium outputted may have two sets or multiple sets of four-color (CMYK) horizontal lines to reduce the waste of sheet medium upon calibrating. Each horizontal line records at least two image forming substances. The linear image sensor 280 scans the four horizontal lines at the speed V. If the four image lines generated by the scanning present the angle θ with respect to the horizontal line, it represents that all the four image forming assemblies are perpendicular to the direction A. If the angle is not θ, then the angle difference can be found, and the difference is used to control the calibration of the system. In this embodiment, the linear image sensor 280 is disposed over the belt assembly 250 with the long side LS of the linear image sensor 280 being disposed across two opposite edge portions 250A and 250B of the belt assembly 250, which are connected to form a straight line 250L perpendicular to the running direction A of the belt assembly 250. Also, the belt assembly 250 is wider than the linear image sensor 280.

In addition to the calibration of parallelism between the image forming assemblies, the distance relationship between the image forming assemblies must also be known. If the distance d1=d2=d3=d is designed and when the first print line (horizontal line) is sensed by the image sensing element Ix, then after the time t has elapsed, the second print line (horizontal line) should also be sensed by the image sensing element Ix, where t=d1/V. Similarly, after the times t and 2t have elapsed, the third and fourth print lines should also be sensed by the image sensing element Ix. However, after the time t has elapsed, the second print line is not sensed by the image sensing element Ix, but is sensed by the image sensing element Ix−1, and it represents that d1 is greater than d. Because both the distance and the angle θ between the image sensing elements Ix and Ix−1 are known, the difference between d1 and d can be easily calculated to serve as the basis for calibrating the print control system. If the second print line is sensed by the image sensing element Ix+1 after the time t has elapsed, then it represents that d1 is smaller than d. The distances d2 and d3 can be computed in the same way, and the computed error is calibrated by the processor. This is a calculation method that can achieve the technology of this disclosure, but the computation of the calculating method is not restricted thereto.

In one example, the linear image sensor 280 is disposed downstream of the four image forming assemblies and forms an angle θ with the horizontal line HL, and the criteria for the control system to calibrate the printing precision should be that the detected parameters of image forming substances should satisfy sin(θ)=β/α. For example, when the linear image sensor 280 detects that the relative position of the first image forming substance KP2 to the first image forming assembly 210 corresponds to the position of the image sensing element 13 at the first time t1, and detects that the relative position of the second image forming substance KPx to the first image forming assembly 210 corresponds to the position of the image sensing element Ix at the second time t2, then the calculated corresponding height β is (t2*V−t1*V). If the result obtained after the control system has computed (a is a span and may be obtained after multiplying the gap of the image sensing element by (x−2)) is different from the value of the predetermined sin(θ), then it represents that the print parameters, such as the print speed (the rotation speed of the image forming assembly), the position or angle at which the image forming assembly is disposed and the like, need to be adjusted.

In this embodiment, the unit of the pixel sensed by the linear image sensor 280 can be smaller than those of the image forming assemblies 210, 220, 230 and 240. That is, the linear image sensor 280 has the higher resolution. Such a design makes the detection results more accurate. More particularly, because the linear image sensor 280 is disposed at an angle θ, the detection results of the overall print precision control system are more precise. The skewed design of such the linear image sensor 280 makes software or firmware computations more easier, and can easily and quickly obtain the deviation amount in the vertical direction and the horizontal direction in FIG. 4.

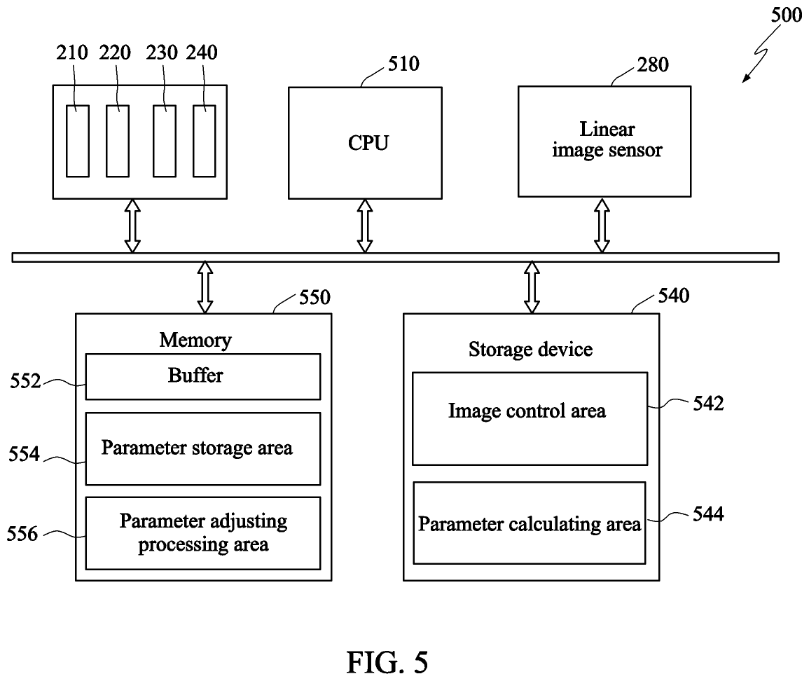

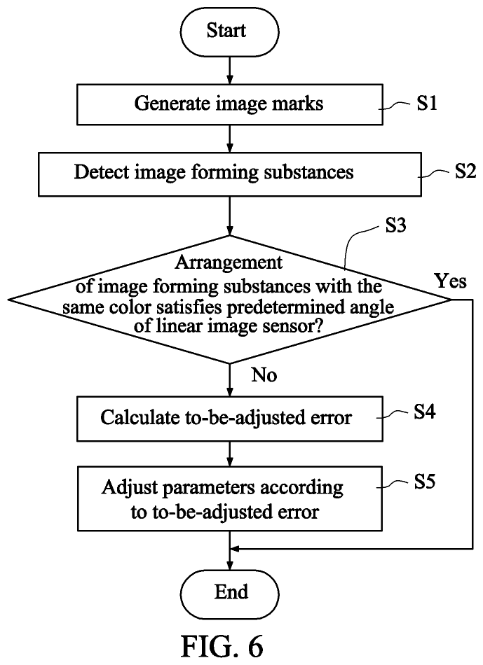

According to the printing precision calibrating structure of this disclosure, this disclosure provides a printing precision calibrating method. FIG. 5 is a block diagram showing a control system of this disclosure, and FIG. 6 is a flow chart showing an example of the control system of this disclosure. Referring to FIGS. 5 and 6, this disclosure provides the printing precision calibrating method applied to a color printer 500. The color printer 500 includes a processor or central processing unit (CPU) 510, image forming assemblies 210, 220, 230 and 240, a linear image sensor 280, a storage device 540 and a memory 550, such as a random access memory (RAM). These components are connected together through a bus for signal transmission. The printing precision calibrating method includes the following steps. In a step S1, the image forming assemblies 210, 220, 230 and 240 are used to generate image forming substances (i.e., image marks), for example, and the CPU 510 reads the program codes and data from the storage device 540 to the memory 550 to control the image forming assemblies 210, 220, 230 and 240 to generate the image forming substances with different colors, wherein the image forming substances with a single color form a horizontal line pattern (in other examples, other patterns may be formed), and the image forming substances can be carried on the belt assembly 250, and can also be carried on the sheet medium. In a step S2, the linear image sensor 280 is used to detect the image forming substances passing by the linear image sensor 280 to obtain a detected result, for example, the CPU 510, electrically connected to the liner image sensor 280, reads the program codes and data from the storage device 540 to the memory 550 to control the linear image sensor 280 to perform the detection. In a step S3, for example, the CPU 510 reads the program codes and data from the storage device 540 to the memory 550, and calculations are made according to the positions of the image forming substances and the detected time instants as the parameter data to calculate whether the arrangement of the image forming substances with the same color (e.g., KP1 to KPn of FIG. 4) satisfies the predetermined angle of the linear image sensor 280 according to the detected result. In the step of using the linear image sensor 280 to detect the passed image forming substances, colors and time instants of the image forming substances detected by the linear image sensor are stored in a temporary storage area (buffer) 552 of the image forming assembly of the memory 550. If the judgment result of the step S3 is affirmative, then there is no need to perform the printing precision calibration. If the judgment result of the step S3 is negative, then there is a need to perform the printing precision calibration. At this time, the CPU 510 computes data of the temporary storage area 552 of the image forming assembly to obtain parameters of the image forming substances, such as the offset, skew, magnification power (width), print positioning (leading edge/side edge), wherein these parameters are stored in a parameter storage area 554 of the image forming substance in the memory 550 and is to be used in the subsequent step S4. In the step S3, the CPU 510 reads program codes stored in a parameter calculating area 544 of the image forming substance of the storage device 540 to the memory 550 to perform the computation. After the printing precision calibrating, the four-color (CMYK) overprint positions corresponding to the same color of pixel points approach the normal standard positions in the next print, so that the color printing result has no overprint error and deviation.

The linear image sensor 280 is disposed according to a predetermined angle, the CPU 510 calculates the positions and the states of the image forming substances by taking the predetermined angle as standard basis, wherein the predetermined angle ranges from 0 to 45°; preferably from 0 to 10°; more preferably from 1 to 5°; and most preferably from 0.1 to 3°. In order to meet the small space requirements, the provision of the linear image sensor 280 should not affect the original space allocation of the color printer, and the angle is as small as possible.

In the step S4, the computed parameters for the offset, skew, magnification power (width), print positioning (leading edge/side edge) are stored in a parameter adjusting processing area 556 of the image forming substance of the memory 550 to calculate a to-be-adjusted error. The step may be performed by the CPU 510, which reads program codes and/or data stored in a computing module of the storage device 540 to the memory 550. Then, a step S5 is performed, wherein the CPU 510 adjusts the parameters according to the to-be-adjusted error, and when the next print is performed, the above-mentioned parameters are applied to an image control area 542 of the image forming assembly of the storage device 540 for the operation. The to-be-adjusted error can be stored in the storage device 540, so that the storage device 540 can still be used after it is rebooted. It is worth noting that the division of the storage device 540 and the memory 550 is only an exemplified description and does not limit this disclosure thereto.

In summary, the printing precision calibrating structure of the embodiment of this disclosure mainly needs a linear image sensor, so that not only the assembly but also the calibration computations are relatively simple. In the calculation and computation processes, at least two reference points are required to achieve the objective of this disclosure, and there is no need for complicated patterns or software calculations. Because the linear image sensor is used, different reference points (image sensing elements) can be used under different circumstances.

While this disclosure has been described by way of examples and in terms of preferred embodiments, it is to be understood that this disclosure is not limited thereto. To the contrary, it is intended to cover various modifications. Therefore, the scope of the appended claims should be accorded the broadest interpretation so as to encompass all such modifications.

1. A color printer, comprising:
multiple image forming assemblies generating image forming substances, which have different colors and are transfer-printed onto a belt assembly;
a contact image sensor (CIS) detecting the image forming substances on the belt assembly passing by the CIS to obtain a detected result; and
a processor, which is electrically connected to the CIS, receives the detected result and determines whether an arrangement of the image forming substances with a same color satisfies a predetermined angle of the CIS according to the detected result.

2. The color printer according to claim 1, wherein the colors of the image forming substances detected by the CIS are stored in a buffer of a memory of the color printer.

3. The color printer according to claim 1, wherein the CIS is configured according to the predetermined angle, and the processor calculates positions and states of the image forming substances based on the predetermined angle.

4. The color printer according to claim 1, wherein the predetermined angle is an angle between a long side of the CIS and a horizontal line substantially parallel to a connection line connecting the image forming substances, having the same color, together.

5. The color printer according to claim 1, wherein the predetermined angle is an angle between a long side of the CIS and a horizontal line substantially parallel to an axial direction of one of the image forming assemblies.

6. The color printer according to claim 1, wherein calculations are made by the processor according to positions and detected time instants of the image forming substances serving as parameter data.

7. The color printer according to claim 1, wherein if the arrangement of the image forming substances with the same color does not satisfy the predetermined angle of the CIS, then the processor calculates a to-be-adjusted error.

8. The color printer according to claim 7, wherein the processor reads program codes provided in a computing module of a storage device to calculate the to-be-adjusted error.

9. The color printer according to claim 7, wherein the processor calibrates printing parameters of the image forming assemblies according to the to-be-adjusted error to achieve effects of color registration and color alignment.

10. The color printer according to claim 1, wherein the CIS is disposed downstream of the image forming assemblies, upstream of a transfer printing portion where the image forming substances are transfer-printed from the belt assembly onto a sheet medium, and upstream of a discharge roller and a fixing unit of the color printer.

11. The color printer according to claim 1, wherein the colors comprise four colors.

12. The color printer according to claim 1, wherein each of the image forming assemblies generates the image forming substances arranged only in a horizontal line or multiple separate pixels sensed by the contact image sensor.

13. The color printer according to claim 12, wherein the image forming assemblies generate the image forming substances at different time instants to shorten extending ranges of the image forming substances generated by different ones of the image forming assemblies in a forwarding direction of the image forming substances.

14. The color printer according to claim 1, wherein the CIS is disposed over the belt assembly with a long side of the CIS being disposed across two opposite edge portions of the belt assembly, which are connected to form a straight line perpendicular to a running direction of the belt assembly.

15. The color printer according to claim 1, wherein the belt assembly is wider than the CIS disposed over the belt assembly.
